(19) United States
(12) Patent Application Publication
(10) Pub. No.: US 2008/0112005 A1
(43) Pub. Date: May 15, 2008

(54) INTEGRATED PICTURE-MANAGEMENT AND PRINTING APPARATUS

(76) Inventors: Richard A. Murray, San Diego, CA (US); John F. Manard, San Diego, CA (US); Del R. Doty, Carlsbad, CA (US); William C. Hilliard, Poway, CA (US)

Correspondence Address: David A. Novais;Eastman Kodak Company, Patent Legal Staff, 343 State Street, Rochester, NY, 14650-2201, US

(21) Appl. No.: 11/558,626

(22) Filed: Nov. 10, 2006

(51) Int. Cl. G06F 15/00

(52) U.S. Cl. 358/1.15

(57) ABSTRACT

An integrated picture-management and printing apparatus is provided that includes many of the components and functions included in conventional commercial picture kiosks in a single printer housing suitable for home use. Accordingly, hardware redundancies present in conventional commercial kiosks are reduced. Further, the printer housing is provided with a display, such as a touch screen display, that may be large relative to the size of the printer housing. Having a large display relative to the printer housing provides additional functionality and makes the execution of functionality more efficient than in conventional devices that have smaller screens.

### FIELD OF THE INVENTION

This invention relates to an integrated picture-management and printing apparatus. In particular, the present invention relates to an integrated picture-management and printing apparatus suitable for, among other things, home use.

### BACKGROUND OF THE INVENTION

Commercial photo kiosk systems have been developed to allow users to bring digital pictures to a public place, such as a retail store, and print their digital pictures customized to their preferences. These preferences may include correcting for image artifacts, such as red eye, choosing a particular portion of the image to print, printing in black and white vs. color, and printing in different sizes. Commercial photo kiosks thus provide advantages to the user in terms of getting the types of prints they want in a moderate amount of time.

However, there are several shortfalls to commercial photo kiosks. 1) They are too large and expensive to be used practically in a home environment. 2) Because commercial kiosks are in public places, they lack the flexibility of being able to be accessed at any time—if the store is closed, the user needs to wait until it is open. 3) Even if the store is open, there is significant extra time spent in getting to the store, standing in line, paying for the service, and getting home. 4) Particularly if there is a line waiting, the user can feel pressure to hurry through the user's photo modifications, resulting in mistakes or non-optimal results, and a less pleasurable experience. 5) The printing environment may also be non-ideal from the standpoint of being noisy or crowded. 6) The public nature of the environment compromises privacy and security while photos are being printed—for example, the user may be uncomfortable using secure passwords to access web accounts, folders, etc. without risk of theft. 7) The user has a limited number of media choices—typically, for example, there may be limited different sizes available, and only a single finish, such as glossy, matte, or luster. 8) The user has a limited number of ink choices. 9) The user is not able to personalize a default group of settings to be used routinely.

An alternative to printing digital pictures with commercial photo kiosks, users can print their pictures on home printers. However, such home printers often are not user friendly. For example, conventional home printers have small (on the order of less than 3″) displays that allow a user to awkwardly view and perform minor image manipulation techniques. Any serious image editing, or any digital picture portfolio management, requires the use of a home personal computer instead.

Accordingly, there is a need in the art for an improved digital picture management and printing solution.

### SUMMARY

The above-described problems are addressed and a technical solution is achieved in the art by an integrated picture-management and printing apparatus according to various embodiments of the present invention. In one embodiment of the present invention, a picture-management and printing apparatus is disclosed, which includes a printer housing, a display, a power supply system, and a user-input system. The display is communicatively connected to the printer housing, and the power supply system includes one or more power supplies configured to provide power to the apparatus. The user-input system includes one or more user-input devices.

According to an embodiment of the present invention, the printer housing is a single device that includes a processing system, a data interface, a memory system, and a printing system. Conventional commercial kiosks, on the other hand, often include separate processing devices and printing devices. Accordingly, these embodiments of the present invention provides a smaller, low-cost kiosk, that is suitable for, among other things, private, home use. In addition, by avoiding having separate devices for processing and printing, hardware redundancies present in commercial kiosks, such as separate power supplies and separate CPUs for the separate devices, may be avoided.

According to an embodiment of the present invention, the processing system includes one or more processors communicatively connected. In addition the data interface is communicatively connected to the processing system and is configured at least to receive digital picture data from outside the printer housing.

The memory system, according to an embodiment, includes one or more processor-accessible memories communicatively connected to the processing system and configured to store at least an operating system program and a picture-management program. The operating system program includes processor-readable instructions configured at least to instruct the processing system to operate. The picture-management program includes processor-readable instructions configured at least to instruct the processing system to manage the received picture data according to input received from the user-input system. According to an embodiment of the present invention, the managing of the received picture data includes printing at least some of the picture data.

The printing system, according to an embodiment of the present invention is communicatively connected to the processing system and is configured to print pictures from at least some of the received picture data when instructed according to the picture-management program. According to this embodiment, the user-input device or devices of the user-input system is/are communicatively connected to the processing system.

According to an embodiment of the present invention, at least one of the user-input devices is integrally formed with the printer housing. Alternatively or in addition to, one of the user-input devices may also be integrally formed with the display, such as, for example, a pressure-sensitive touch-input screen for the display. In this case, the display acts as a touch-screen display.

According to an embodiment of the present invention, a width of the display is at least 20% percent of a width of the printer housing. According to another embodiment, a width of the display is no greater than approximately 90% percent of the width of the printer housing. According to an embodiment of the present invention, the display is sufficiently large to allow a user, via a touch screen display, to use their fingers to perform complex digital picture editing and portfolio management, as compared to conventional home printers. On the other hand, integrated picture-management and printing apparatuses, according to embodiments of the present invention, are lower cost and smaller in size than home personal computers with attached printers.

According to an embodiment of the present invention, the printer housing includes one or more of a variety of data interfaces that allow data to be received by the printer housing. For example, the printer housing may include a wired or wireless network interface that allows digital pictures to be received by the printer housing from remote computers, such as from a web server located remotely via the internet. In this situation, a user can retrieve, view, edit, and print digital pictures from an online picture-management service, such as Kodak EasyShare Gallery. In addition or alternatively, the printer housing may include a USB interface, a CD/DVD interface, a fire wire interface, or a memory card interface. Further, the printer housing may include internal data storage facilities, such as an internal hard disk drive that can retain a users digital pictures in a picture repository. Such an arrangement further increases a users ability to manage their digital picture portfolios, functionality of which is not provided by conventional commercial kiosks and conventional home printers.

According to another embodiment of the present invention, the display is detachable from the printer housing. According to this embodiment, both the display and the printer housing include their own wireless data communication devices that are communicatively connected to each other. According to this embodiment, a user can detach the display from the printer housing, and view, edit, and print their digital pictures remotely from the printer housing. In this case, the display includes its own power supply, such as a battery, that charges when the display is connected to the printer housing, and the printer housing is plugged into a power source.

On the other hand, in the embodiments of the present invention where the display is fixedly connected to the printer housing, the entire picture-management and printing apparatus, may include only a single power supply and/or a single, shared central processing unit. In this case, hardware redundancies present in conventional commercial kiosks, can be reduced or avoided. In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments presented below considered in conjunction with the attached drawings, of which:

FIG. 1 illustrates an integrated picture-management and printing apparatus, according to an embodiment of the present invention;

FIG. 2 illustrates programs stored by a memory system in a printer housing, according to an embodiment of the present invention;

FIG. 3 illustrates a perspective view of the integrated picture-management and printing apparatus, according to an embodiment of the present invention, where multiple digital images are displayed to a user simultaneously;

FIG. 4 illustrates a side view of a picture-management and printing apparatus, according to an embodiment of the present invention;

FIG. 5 illustrates a perspective view of a picture-management and printing apparatus, according to an embodiment of the present invention, where a user is editing a displayed digital picture via a touch screen display; and

FIG. 6 illustrates a picture-management and printing apparatus with a display that is disconnectable from the picture housing, according to an embodiment of the present invention.

It is to be understood that the attached drawings are for purposes of illustrating the concepts of the invention and may not be to scale.

### DETAILED DESCRIPTION

Embodiments of the present invention provide a picture-management and printing apparatus that includes a single printer housing that, itself, includes many of the components and provides many of the functions conventionally associated with commercial picture kiosks. Because such components and functionality are provided by a single printer housing, hardware redundancies present in conventional commercial picture kiosks can be reduced or eliminated. On the other hand, these embodiments include capabilities that exceed that of conventional home printers. For example, according to an embodiment of the present invention, a relatively large display that is communicatively connected to the printer housing is provided to allow a user to effectively execute many additional functions as compared to conventional home printers. For another example, according to an embodiment of the present invention, the printer housing is provided with a long-term internal data storage mechanism that allows it to retain pictures such as in a picture repository, to facilitate increased picture-archive-management functionality for a user. These and additional advantages will be described in further detail below.

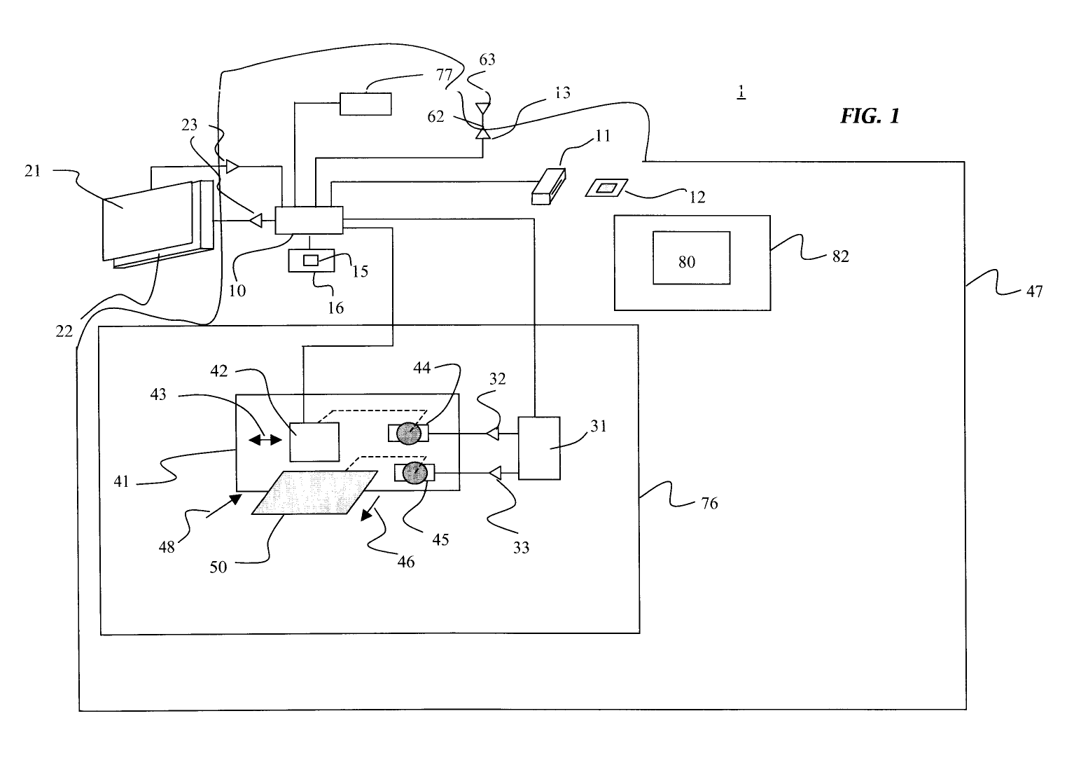

Turning now to FIG. 1, a picture-management and printing apparatus 1 is illustrated, according to an embodiment of the present invention The apparatus 1 includes a printer housing 47 communicatively connected to a display 22. The phrase “communicatively connected” is intended to include any type of connection, whether wired, wireless, or both, between devices and/or programs in which data may be communicated. Further, the phrase “communicatively connected” is intended to include a connection between components within a single device. In this regard, although the figures often illustrate components as being schematically separate, one skilled in the art will appreciate that such components could in fact be located within a same device.

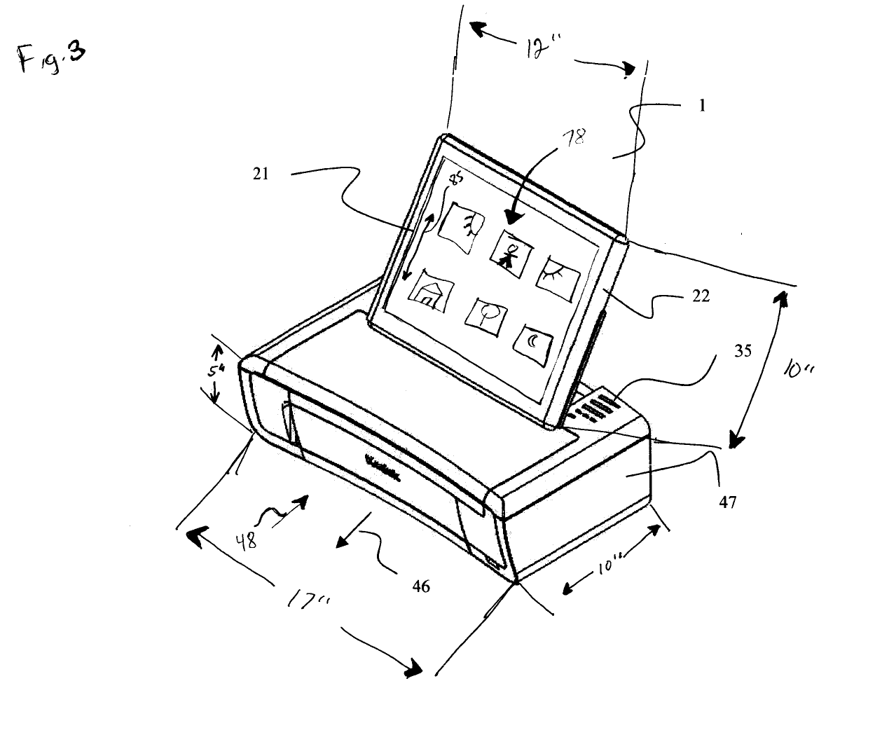

According to the embodiment of FIG. 1, the apparatus 1 includes a user input system configured to receive user-input data. The user input system is represented in this embodiment as including a touch pad 21. In this case, the display 22 is configured as a touch-screen display. One skilled in the art will appreciate, however, that the touch pad 21 is merely an example of a data-input device in the user input system, and that other or additional data-input devices may be used. For example, the user input system may include printer housing control buttons 35 integrated with the printer housing 47, as shown in FIG. 3. Other non-limiting examples include an external mouse or a pointing device communicatively connected to the printer housing 47.

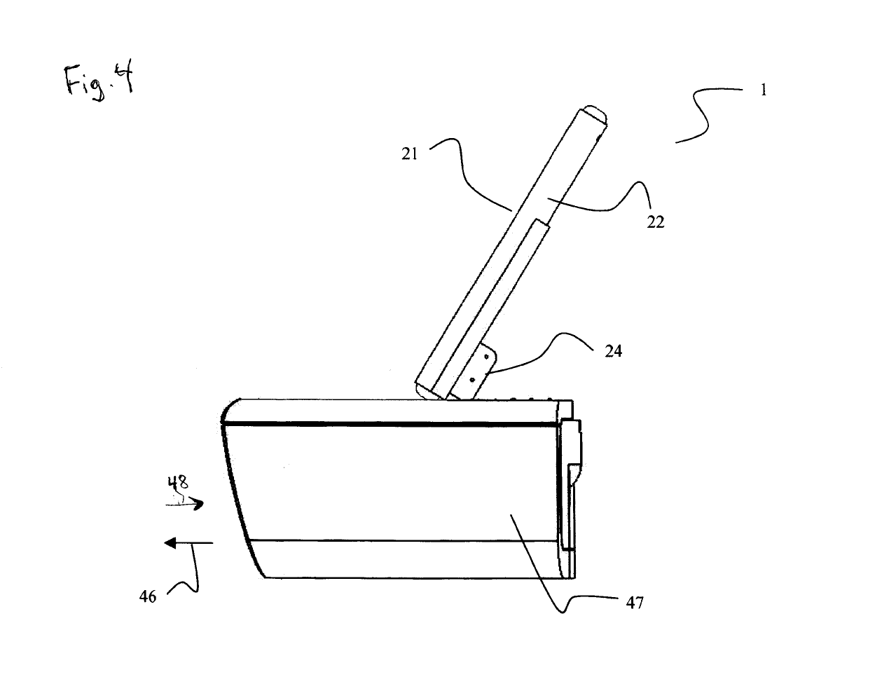

FIG. 3 illustrates a perspective view of the display 22 communicatively connected to the printer housing 47. Dimensions included in FIG. 3 are example dimensions, and one skilled in the art will appreciate that the invention is not limited to these dimensions. A side perspective is illustrated with FIG. 4, which includes a display mounting bracket 24 that rotatably mounts the display 22 to the printer housing 47. In this regard, the display 22 can be folded to reduce the overall size of the apparatus 1, thereby allowing it to be more easily stored or transported.

As shown in FIGS. 3 and 4, the display size of the display 22 is large relative to the size of the housing 47. In particular, according to an embodiment of the present invention, a width of the display 22 is at least 20% percent of the width of the printer housing 47. In the embodiment of FIG. 3, the width of the display 22 is approximately 70% of the width of the printer housing 47. However, one skilled in the art will appreciate that larger percentages, such as up to 90% or more, are included within the scope of the invention. In an embodiment of the present invention, the width of the display 22 is no greater than 90% of the width of the printer housing 47. However, one skilled in the art will appreciation that larger percentages are included within the scope of the invention. As will be described in more detail below, a large screen relative to the size of the printer housing allows a user to execute more functions and more functions effectively than conventional home printers.

The picture-management and printing apparatus 1, according to the embodiment of FIG. 1, also includes a power supply system 82, which in this case includes a single power supply 80 located within the printer housing 47. The power supply 80 provides power to the entire apparatus 1. Accordingly, power supply redundancies, present in commercial kiosks, may be avoided, if desired. In this regard, the apparatus 1, may have power requirements less than 300 W, less than 200 W, and as low as approximately 100 W. In contrast, conventional commercial kiosks require on the order of 1000 W of power. Further, by reducing hardware redundancies, such as power supplies, the size and weight of the apparatus 1 is reduced over conventional commercial kiosks. For example, the apparatus 1, according to an embodiment of the present invention weighs less than 25 lbs, and another embodiment has the apparatus 1 weighing approximately 10 lbs. On the other hand, conventional commercial kiosks often weigh hundreds of pounds more.

Further in this regard, the printer housing 47 illustrated in the embodiment of FIG. 1 includes a processing system 10 that is communicatively connected to the user input system (21, for example). The processing system 10 may include one or more data processors. However, in the interest of reducing redundant hardware as compared to conventional commercial photo kiosks, the processing system 10 may include a single CPU or (system on a chip “S.O.C.”) shared by all components of the apparatus 1. In contrast to conventional home printers, the processing system 10 exhibits increased digital picture management, editing, and printing capabilities, as described in more detail below.

Still further in regard to hardware redundancy reduction as compared to conventional commercial kiosks, the apparatus may have a reduced number of data interfaces, drivers, wiring harnesses, and reduced working memory.

The printer housing 47 includes one or more data interfaces communicatively connected to the processing system 10 and configured at least to receive digital picture data from outside the printer housing 47. In the embodiment of FIG. 1, a memory card reader 11 is illustrated as a data interface. However, one skilled in the art will appreciate that other data interfaces or additional data interfaces, such as a USB interface, a compact disc interface, a DVD interface, a fire wire interface, etc. may be provided. In the case of FIG. 1, the memory card reader 11 is configured to receive a memory card 12 having digital picture data stored thereon.

The embodiment of FIG. 1 also illustrates a network interface 13 included as a data interface of the printer housing 47. The network interface 13 may be a wired network interface, such as an Ethernet interface, or a wireless network interface such as a wireless radio interface or Ethernet FI. The network interface 13 may be used to retrieve digital picture data from a remote computer, such as a web server 63 via the internet 62. According to this embodiment, a user can use the apparatus 1 to manage, edit, and print digital pictures stored by an on-line picture-management service provider, such as Kodak EasyShare Gallery.

Upon receipt of digital picture data from the data interface(s), the processing system 10 may be configured store such data in a memory system 16 communicatively connected thereto. The memory system 16 may include one or more communicatively connected processor-accessible memories. In one embodiment of the present invention, the memory system 16 includes a nonvolatile processor-accessible memory with which the processing system 10 stores picture data. An example of a nonvolatile processor-accessible memory is a hard disk drive 15.

Also included in the printer housing 47 is a printing system 76, which, according to an embodiment of the present invention, may be an ink jet printer. The printing system 76 is communicatively connected to the processing system 10, and is configured to, at least, print digital pictures on media 50 upon instruction from the processing system 10. Examples of media 50 include, but are not limited to, large (e.g., greater than or equal to 8×10) or small (e.g., less than 8×10) glossy, luster, or matte media. An advantage of the printer housing 47 being configured to use multiple different types of media, compared to commercial kiosks is that a user can print their photos on any number of user-installable types of media. Whereas, conventional commercial kiosks are limited in this regard.

Additionally, in the case of an ink-jet printer, the printing system 76 may be configured to retain user-replaceable ink tanks and/or printheads. Because the ink tanks and/or printheads are user-replaceable, it is simple for a user to install specialty inks (besides standard C, M, Y, K, inks) such, for example, as spot color inks, metallic inks, and fluorescent inks etc.

The printing system 76 of FIG. 1 includes a printer mechanism 41 and a control circuit 31. The printer mechanism 41 includes, according to this embodiment, a printhead 42, which may be an ink jet printhead. The control circuit 31 receives instructions from the processing system 10 to, at least, control a carriage scan motor driver 32 and a paper advance motor driver 33 that respectively drive carriage scan motor 44 and paper advance motor 45 of the printer mechanism 41. Arrow 43 illustrates a carriage scan direction X, arrow 48 illustrates a paper input advance direction Y, and arrow 46 illustrates a paper output advance direction minus Y.

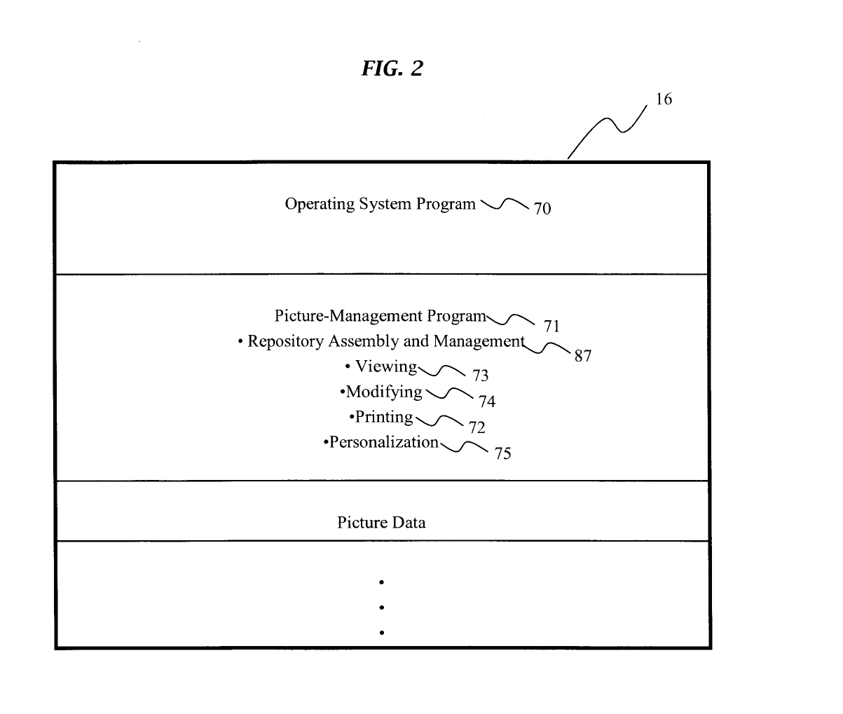

Turning now to the embodiment of FIG. 2, example data contents of the memory system 16 are illustrated. According to this embodiment, the memory system 16 retains, among other things, an operating system program 70, a picture-management program 71, and, optionally, picture data. The operating system program includes processor-readable instructions configured at least to instruct the processing system 10 to operate. The picture-management program 71 includes processor-readable instructions configured at least to instruct the processing system to manage the received picture data according to input received from the user-input system.

According to an embodiment of the present invention, the managing of the received picture data includes assembling and managing a digital picture repository based at least upon the received picture data. According to an embodiment of the present invention, the managing of the received picture data includes printing one or more digital pictures from the digital picture data. According to other embodiments of the present invention, the managing of the received picture data includes display digital pictures for a user on the display 22, and the modifying of digital pictures displayed on the display 22 via inputs received from the user-input system. The picture-management program 71 may include user preferences 75 that instruct the processing system 10 to store user preferences in the memory system 16. Examples of user preferences include user-preferred digital picture naming conventions, user-preferred digital picture appearance preferences, etc., associated with one or more users of the apparatus 1.

In regard to the digital picture repository management functionality 87 of the picture-management program 71, the processing system 10 may be instructed to assemble a digital picture repository based at least upon the picture data received from the data interfaces. Such assembling may occur automatically with the processing system 10 querying all communicatively attached devices to see if they have digital pictures, may occur manually via input received from the data input system of the apparatus 1, or may occur both automatically and manually.

Some or all of the digital pictures in the picture repository may be stored internally within the apparatus 1, or some or all of the digital pictures may be stored externally from the apparatus 1. The digital pictures in the picture repository stored externally to the apparatus 1 may remain accessible to the apparatus 1 via the data-interface(s) of the apparatus 1.

In addition to assembling a picture repository, the digital picture repository management functionality 87 instructs the processing system 10, in response to input received from the user-input system to manage the digital pictures in the picture repository. Examples of managing the digital pictures include, generating and maintaining thumbnail images of the digital pictures; associating meta data, which may include text descriptions and keywords, with the digital pictures; providing digital-picture search capabilities to a user, such searching including searching the meta data and/or file names; and cataloging or categorizing the digital pictures in the repository, such cataloging or categorizing being performed based at least upon the meta data.

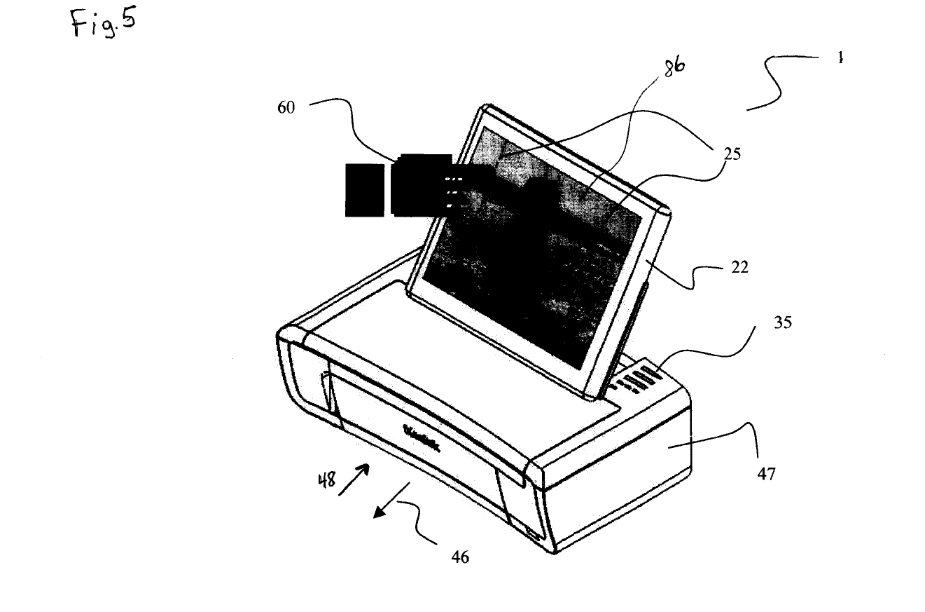

In regard to the viewing functionality 73 of the picture management program 71, FIG. 3 illustrates a plurality of digital pictures 78 displayed simultaneously on the display 22. According to this embodiment, the size of the display 22 is sufficient enough for a user to display the plurality of digital pictures 78 simultaneously and view them at an adequate size. According to an embodiment of the present invention, the display 22 is sufficiently large to display four or more digital pictures simultaneously, each having a size equal to or greater than 1 inch by 1.5 inches. A user can peruse their digital pictures by selecting, via a user input device, such as the touch screen 21, a scroll bar 85. However, one skilled in the art will appreciate that any digital picture navigation technique may be used instead. In addition, a user can use a user-input device, such as the touch screen 21 or the printer housing control buttons 35, to select a particular picture for viewing or modifying, as shown in FIG. 5.

According to an embodiment of the present invention, the picture management program 71 includes modification functionality 74 (FIG. 2) that allows a user to edit digital pictures. In embodiments where the apparatus 1 is configured for non-retail or non-commercial use, such as home use, the picture modification functionality 74 may exceed that of conventional commercial kiosks. For example, if the apparatus 1 is used in a home environment, users are able to spend more time editing their digital pictures and more time learning to use the modification functionality 74. In this regard, more complex editing functions may be provided in the modification functionality 74 as compared to conventional commercial kiosks, where usage time is limited, the accompanying software must be simple to learn and use quickly for everyone in the public generally. Examples of such more detailed image modification functionality that may be provided as part of modification functionality 74 include the generation of creative content that is more time-intensive than that provided for in a commercial or retail environment. In particular, modification functionality 74 may allow users to download, create, and/or use personalized image borders, photo book templates, and free-hand or other tool-based drawing functions. However, more standard image-modification techniques, such as contrast modification, brightness modification, scene balancing, red-eye reduction, zooming, cropping, sharpness adjustment, color enhancement, or combinations thereof may be provided as part of the functionality 74. Accordingly, one skilled in the art will appreciate that the modification functionality 74 may include, in addition to editing functions used by conventional commercial kiosks, more time-consuming and/or complex editing functions not practically usable in a commercial or retail setting where time and/or privacy is/are limited.

Without limiting the discussion in the preceding paragraph, FIG. 5 illustrates as a simple example, for purposes of clarity, a cropping function performed on a selected picture 86 being viewed on the display 22, according to the modification functionality 74. In this case, a user can edit a selected picture 86. In the embodiment of FIG. 5, a user is using his or her hand 60 to produce user-defined crop lines 25 to crop the selected picture 86.

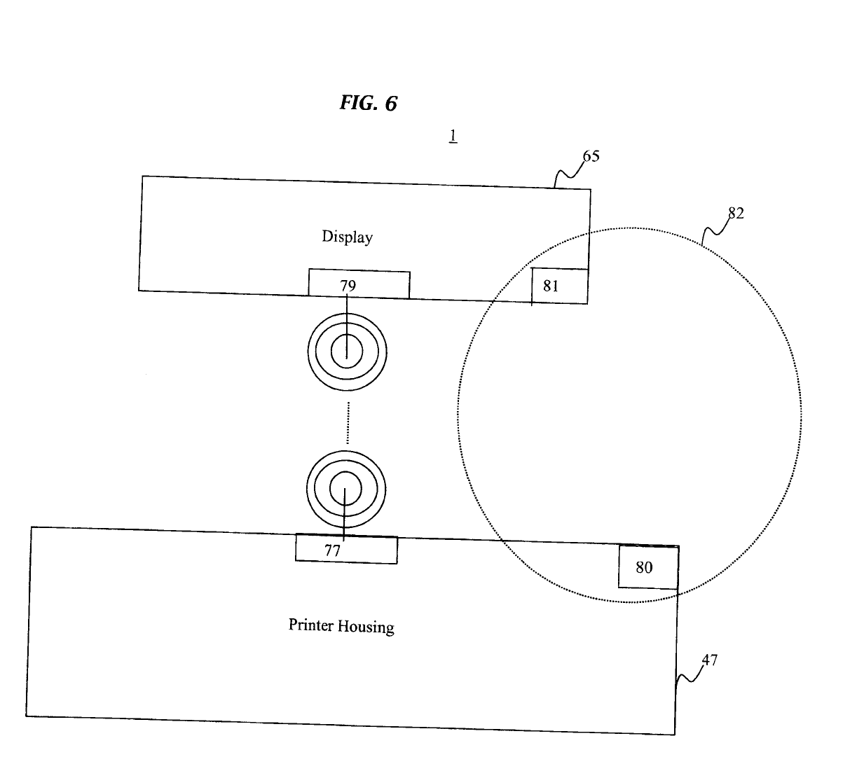

FIG. 6 illustrates an embodiment of the present invention where, in the apparatus 1, a detachable display 65 is provided that can be disconnected from the printer housing 47. According to this embodiment, the printer housing 47 includes a first wireless data communication device 77, such as a Bluetooth device, and the display 22 includes its own wireless communication device 79 (“second wireless data communication device”), such as a Bluetooth device. The display 22 and the printer housing 47 maintain their communicative connection via a communicative connection between the wireless communication devices 77, 79. According to this embodiment, users may manage, edit, and print their digital pictures remotely from the printer housing 47 by carrying the display 65 with them. In this regard, the display 65 includes its own power supply 81, such as a battery, separate from the power supply 80 included in the printer housing 47. Accordingly, the power supply system 82, in this embodiment, includes both power supplies 80, 81.

The power supply 81 may be charged when the display 22 is connected to the printer housing 47, and the printer housing has its power supply 80 plugged into a power source. Alternatively, the display may have its own charging mechanism.

It is to be understood that the exemplary embodiments are merely illustrative of the present invention that many variations of the above-described embodiments can be devised by one skilled in the art without departing from the scope of the invention. It is therefore intended that all such variations be included within the scope of the following claims and their equivalents.

### PARTS LIST

1 Picture management and printing apparatus
10 Processing System
11 Memory card slot reader
12 Memory card
13 Network interface
15 Hard disk drive
16 Memory system
21 Touch pad
22 Display
24 Display mounting bracket
25 Modified digital picture
31 Printer motor control chip
32 Carriage scan motor driver
33 Paper advance motor driver
35 Printer housing control buttons
41 Printer mechanism
42 Printhead
43 Carriage scan direction X
44 Carriage scan motor
45 Paper advance motor
46 Paper output advance direction Y
47 Printer housing
48 Paper input advance direction Y
49 Lid for housing
50 Printed pictures on media
60 Hand modifying digital picture
62 Internet
63 Web server
65 Detachable display
70 Operating system program
71 Picture-management program
72 Printing pictures from digital picture data
73 Simultaneously perusing pictures on display
74 Modify pictures from digital picture data
75 Retain user preferences
76 Printing system
77 First wireless data communication development
78 Plurality of digital pictures displayed simultaneously
79 Second wireless communication device
80 Power supply for printer housing
81 Power supply for detachable display
82 Power supply system
85 Scroll bar
86 Selected picture
87 Digital picture repository management functionality

What is claimed is:

1. A picture-management and printing apparatus, the apparatus comprising:
a printer housing;
a display communicatively connected to the printer housing;
a power supply system comprising one or more power supplies and configured to provide power to the apparatus; and
a user-input system comprising one or more user-input devices,
wherein the printer housing comprises:
a processing system comprising one or more processors communicatively connected;
a data interface communicatively connected to the processing system and configured at least to receive digital picture data from outside the printer housing;
a memory system comprising one or more processor-accessible memories communicatively connected to the processing system and configured to store at least an operating system program and a picture-management program, wherein the operating system program includes processor-readable instructions configured at least to instruct the processing system to operate, and wherein the picture-management program includes processor-readable instructions configured at least to instruct the processing system to manage the received picture data according to input received from the user-input system, the managing of the received picture data including printing at least some of the picture data, wherein the managing of the received picture data includes assembling a non-volatile digital picture repository, and the picture-management program further includes processor-readable instructions configured at least to instruct the processing system to manage the digital picture repository based at least upon input received from the user input system; and
a printing system communicatively connected to the processing system and configured to print pictures from at least some of the received picture data when instructed according to the picture-management program, and
wherein the user-input device(s) of the user-input system is/are communicatively connected to the processing system.

2. The apparatus of claim 1, wherein at least one of the user-input devices is integrally formed with the printer housing.

3. The apparatus of claim 1, wherein at least one of the user-input devices is integrally formed with the display.

4. The apparatus of claim 1, wherein one of the user-input devices is integrated with the display, thereby causing the display to be a touch-screen display.

5. The apparatus of claim 1, wherein a width of the display is at least 30% of the width of the printer housing.

6. The apparatus of claim 5, wherein a width of the display is no greater than approximately 90% of the width of the printer housing.

7. The apparatus of claim 1, wherein the managing of the received picture data, according to the picture-management program, includes perusing simultaneously a plurality of digital pictures encoded in the received picture data.

8. The apparatus of claim 1, wherein the managing of the received picture data, according to the picture-management program, includes allowing a user to modify a picture encoded in the received picture data.

9. The apparatus of claim 8, wherein the allowance of a user to modify a picture, according to the picture-management program, includes contrast modification, brightness modification, scene balancing, red-eye reduction, zooming, cropping, sharpness adjustment, color enhancement, the addition of creative content, or combinations thereof.

10. The apparatus of claim 1, wherein the memory system comprises a non-volatile processor-accessible memory configured at least to retain the received image data.

11. The apparatus of claim 1, wherein the data interface is a network interface.

12. The apparatus of claim 11, wherein the network interface is a wired network interface.

13. The apparatus of claim 11, wherein the network interface is a wireless network interface.

14. The apparatus of claim 11, wherein the network interface is configured at least to retrieve image data from the Internet.

15. The apparatus of claim 11, wherein the network interface is configured at least to retrieve image data from a web server.

16. The apparatus of claim 1, wherein the data interface is a USB interface, a CD/DVD interface, a fire wire interface, or memory card interface.

17. The apparatus of claim 1, wherein the display is disconnectably connected to the printer housing, wherein the printer housing further comprises a first wireless data communication device communicatively connected to the processing system, and wherein the display comprises a second wireless data communication device communicatively connected to the first wireless data communication device and configured to communicate data with the first wireless data communication device.

18. The apparatus of claim 1, wherein the display is rotatably mounted to the printer housing.

19. The apparatus of claim 17, wherein the power supply system includes a single power supply located in the printer housing and a single power supply located in the display.

20. The apparatus of claim 1, wherein no other system provides power to the apparatus besides the power supply system, and wherein the power supply system includes only a single power supply that is located within the printer housing.

21. The apparatus of claim 1, wherein the processing system includes only a single CPU.

22. The apparatus of claim 1, wherein the printing system comprises an ink-jet printer.

23. The apparatus of claim 1, wherein the picture-management program includes processor-readable instructions further configured at least to retain user preferences relating to picture-management.

24. The apparatus of claim 1, wherein the managing of the digital picture repository, according to the picture-management program, includes adding meta data to one or more of the digital pictures in the digital picture repository.
